(19) United States
(12) Patent Application Publication
(10) Pub. No.: US 2021/0360886 A1
(43) Pub. Date: Nov. 25, 2021

(54) Controlling Plant Growth Conditions

(71) Applicant: Just Greens, LLC, Newark, NJ (US)

(72) Inventors: Michael Anthony Barron, Philadelphia, PA (US); Edward D. Harwood, Ithaca, NY (US); Roger Buelow, Pepper Pike, OH (US); Justin R. Zabilansky, Brooklyn, NY (US)

(73) Assignee: Just Greens, LLC, Newark, NJ (US)

(21) Appl. No.: 17/255,358

(22) PCT Filed: Jan. 10, 2019
(86) PCT No.: PCT/US2019/013071

§ 371 Date: Dec. 22, 2020

(51) Int. Cl. A01G 31/02; G06Q 50/02

(52) U.S. Cl. CPC A01G 31/02; G06Q 50/02

(57) ABSTRACT

Embodiments of the disclosure relate to apparatus and methods for monitoring plant development in aeroponic farming. The output from one or more sensors in the apparatus be used to modify the flow of one or more fluids to the developing plants.

### CROSS-REFERENCE TO RELATED APPLICATIONS

The present application claims priority benefit to a provisional patent application entitled “Controlling Plant Growth Conditions” that was filed with the U.S. Patent Office on Jun. 26, 2018, and assigned Ser. No. 62/690,029.

### TECHNICAL FIELD

Embodiments of the disclosure relate to systems and method for monitoring developing plants and controlling fluid flow to the plants.

### BACKGROUND

Aeroponic growing generally involves spraying a liquid nutrient solution on the roots of developing plants. The roots of these plants are generally bare and suspended in a growth chamber where the nutrients are sprayed. In some versions of aeroponic farming, seeds are deposited on the top surface of a cloth growth medium that can be supported by a frame. The seeds are germinated, and the cloth/frame assembly is placed in the growth chamber. In the growth chamber, the upper side of the cloth is subjected to light of a wavelength and intensity to promote growth in the developing plants, the underside of the cloth and the developing root mass receives the nutrient solution. The plants resulting from the seeds are harvested at a desired stage of growth. The growth chambers can be stacked on each other and/or located side by side to save space within a facility and to permit sharing the subsystems which provide the nutrient solution, temperature, humidity, and carbon dioxide to the growth chambers. A rapidly developing and healthy plant canopy is beneficial in these systems because it reduces the amount of light that reaches the growth medium and can reduce the formation of harmful algal growth.

The temperature, humidity, and carbon dioxide concentration within the aeroponic growth chamber may operate within specific ranges or at specific values. A plurality of fans can be used to provide air circulation to the growth chamber. Too much air movement near plants will reduce growth and, in some instances, air movement above 50 feet per minute may damage very young plants. Harming or killing one or more of the developing plants, especially those in early development, for example at or before the first true leaf development, inhibits canopy growth, results in increased algal growth, and is undesirable.

Nozzles are generally located below a bottom surface of a flat in the aeroponic growth system and can be used to spray nutrient solution onto the plant roots. The flat may encompass the growth medium, cloth, or soilless medium and the frame. Excess nutrient solution that drips off the roots and cloth bottom surface fails down into a tray below the flat which can return the nutrient solution to a nutrient tank for re-use.

Incomplete coverage of the growth medium, cloth, or soilless medium around the edges of the frame forming the flat can lead to an overspray of the nutrient solution from below the flat onto leaves and stems of the developing plants atop the medium. Holes in the growth medium can also lead to overspray of the developing plants atop the medium.

Excess moisture on the plant leaves and stems from overspray due to holes in the growth medium or gaps at edge of the medium and frame, can lead to growth of harmful algae and plant fungus which can result in rot on the developing plants. Algal and fungal growth on the developing plants, especially those in early development, at or before the first true leaf development, also inhibits canopy growth and is undesirable. The presence of algae and fungus at any stage of plant development can require the destruction of a contaminated flat with loss of yield and increased costs. Mineral deposits on the plant leaves from overspray can also make the plants visibly undesirable to consumers.

Fans have been used to increase the circulation of air in aeroponic growth systems. Air flow systems have also been developed for hydroponic growth systems to provide air supply through plant growth support structures and are used to increase air velocity to protect against stagnation of air in proximity to the plants. These hydroponic growth systems generally provide layered support media with perforations or other openings near the base of the plants to provide an upward flow of air. These air flow systems are expensive to operate and build, and require growth of plants at limited positions which decreases yield.

There is a continuing need for aeroponic growth systems that can reliably establish and maintain a healthy plant canopy to improve yields and reduce costs.

### SUMMARY

Embodiments of the disclosure improve plant canopy establishment in aeroponic and hydroponic growth systems by reducing algae growth resulting from improper fluid delivery, such as high air velocity at early plant development stages, low air velocity in late plant development stages, and/or overspray of nutrient solution. A beneficial plant canopy in an aeroponic or hydroponic growth system can be obtained by an apparatus with a controller that is connected to a sensing system and a fluid supply system. The sensing system characterizes the developing plants, the plant canopy, growth system environment, and any combination of these, and determines based on the characterization, the appropriateness of the fluid flow and whether an action is needed to engender change to the delivery of the one or more fluids to the aeroponic or hydroponic growth system. Unless otherwise stated, aeroponic growth system and hydroponic growth system may be used interchangeably herein.

One embodiment of the disclosure is a sensing system for growth systems having a soilless growth medium, wherein the soilless growth medium may be positioned in close proximity to a frame. The frame may further include at least one nozzle positioned below the growth medium, wherein the nozzle(s) may supply a mist spray or fog spray of a water-based, a nutrient-based, or a water- and nutrient-based solution to the developing plants growing on the growth medium. The sensing system may include a controller and at least one of a sensor and an imaging system in communication with the controller. The at least one sensor/imaging system may be positioned in proximity to the developing plants in an aeroponic growth system to monitor and characterize the developing plants. A fluid supply system may also communicate with the controller to supply fluids to the developing plants in the aeroponic growth system based on an output from the controller to the fluid supply system. The controller may be further operable to obtain an image of the developing plants and/or readouts from one or more sensors, and to characterize these for the developing plants in the growth system. The controller can perform an analysis or characterization of the sensing system inputs, compare these to baseline or library characterization of the developing plants, determine whether a fluid supply state in the growth system is appropriate, and maintain the fluid system in a current state. If the analysis or characterization of the developing plants shows the fluid supply state inputs are outside of a threshold, the controller can engender change in the fluid supply system to modify the supply of the one or more of fluids to the developing plants.

In some embodiments of the disclosure, based upon the analysis or characterization of an image of the developing plants, and optionally inputs from one or more sensors, in the sensing system, the controller can detect an improper gas supply state and engender programmed change to the gas supply state by changing the velocity or flow rate of gas delivered to developing plants in all or a portion of an aeroponic growth system. The change in gas supply may result in better canopy development, a reduction in algae, and increased yields. In other embodiments, upon detection of an improper gas supply state, the controller can engender programmed change to a gas supply state by changing the gas velocity and gas composition delivered to the developing plants in the aeroponic growth system. The initial gas supply state may be a low flow velocity that is increased to one or more subsequent gas supply states with higher flow velocity after one or more specific plant morphologies are detected as determined by the sensing system.

In some embodiments of the disclosure, based upon the analysis or characterization of an image of the developing plants and optionally inputs from one or more sensors received by the sensing system, the controller can detect an overspray condition and engender programmed change to the nutrient supply state by changing the flow of liquid delivered through the nozzle(s) to the developing plants in the aeroponic growth system to correct the overspray condition.

One embodiment of the disclosure is a method of delivering fluid from a fluid supply system to a growth medium containing developing plants in an aeroponic growth system that includes a characterization using a sensing system of the developing plants in the growth system for appropriate fluid delivery to the growth system and determining whether or not to adjust delivery of fluid to the growth medium containing developing plants in the growth system.

Advantageously, limited airflow during early plant development increases canopy development, canopy uniformity, and overall average yield. Improved airflow helps to improve both water use efficiency and CO₂ use efficiency thereby reducing costs. Dynamic airflow and control of overspray during plant development helps to increase canopy development, maximize the yield, and further reduce costs.

### BRIEF DESCRIPTION OF THE DRAWINGS

The drawings accompanying and forming part of this specification are included to depict certain aspects of the disclosure. A clearer impression of the components and operation of systems provided with the disclosure, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 is a schematic illustration of a growth system with developing plants on a growth medium that is interfaced with a controller, a sensing system and a fluid supply system.

FIG. 2 is a flow diagram of one embodiment of a method according to the disclosure.

FIG. 3 is a flow diagram of another embodiment of a method according to the disclosure.

FIG. 4 is a flow diagram of a further embodiment of a method according to the disclosure.

FIG. 5 is a flow diagram of an embodiment of a method related to the gas supply system according to the disclosure.

### DETAILED DESCRIPTION

In the following description, it is understood that terms such as “top,” “bottom,” “outward,” “inward,” and the like are words of convenience and are not to be construed as limiting terms. Reference will now be made in detail to exemplary embodiments of the disclosure, which are illustrated in the accompanying figures and examples. Referring to the figures in general, it will be understood that the illustrations are for the purpose of describing particular embodiments of the disclosure and are not intended to limit the same. These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

Whenever a particular embodiment of the disclosure is said to comprise or consist of at least one element of a group and combinations thereof, it is understood that the embodiment may comprise or consist of any of the elements of the group, either individually or in combination with any of the other elements of that group.

In embodiments of the disclosure, the term “developing plant(s)” can refer to one or more germinating seeds, one or more seedlings with or without true leaves, one or more growing plants, or any combination of these that are on a generally top surface of a growth medium.

The disclosed system senses, characterizes, monitors and controls the growth of developing plants in aeroponic or hydroponic growth systems. The disclosed sensing system provides constant feedback of the growth system such that adjustments may be performed more frequently to ensure developing plants stay within predetermined growing parameters. The disclosed sensing system leverages one or more of a plurality of controller(s), sensors, imaging system(s), and any combination thereof to sense, monitor, characterize and/or control at least one of developing plants and the growth system. Analysis of the growth system ensures developing plants are growing in optimal conditions such that developing plants may grow faster, have increased yields, produce better canopy development, and have less algae.

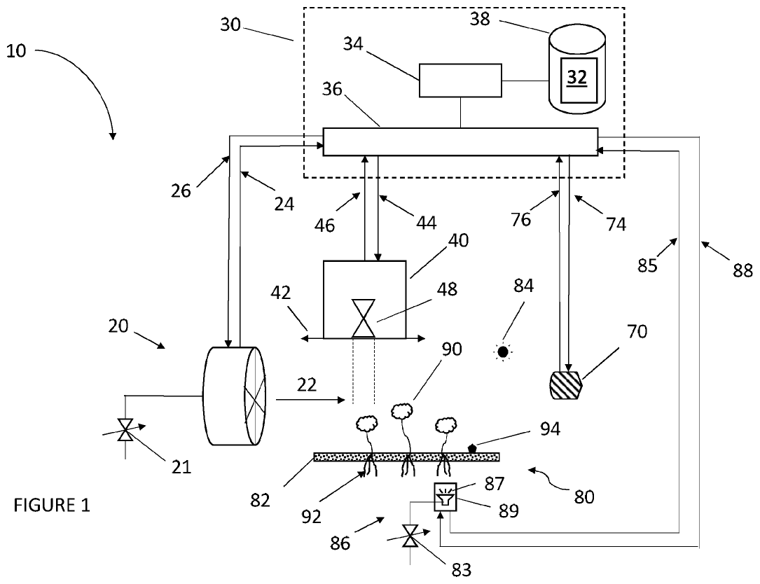

FIG. 1 is a diagrammatic representation of a system 10 in embodiments of the disclosure that can include a fluid supply system and a sensing system connected to a controller and which work together to monitor and provide fluid(s) to seeds and developing plants on a growth medium within a growth system 80. The plant growth system 80 in embodiments of the disclosure can also include a soilless growth medium 82 and a lighting system 84 with one or more lamps configured to supply light of suitable wavelengths to the developing plants. The growth system 80 is operated in embodiments of the disclosure with various combinations of fluid, temperature, humidity, and lighting inputs as needed to grow the plants from seeds to developed plants that can be harvested. Reference to operating the growth system in any fluid supply system state includes providing that the lamps can be turned on and off with the intensity and wavelength as needed for plant development, providing a suitable growing temperature for the growth system, providing the gas velocity and composition as needed for plant development, and providing a water-based, a nutrient-based, or a water- and nutrient-based solution spray in an amount and composition as needed for plant development. The various combinations of growing parameters, as discussed above, may be altered based on the variety of plant growing (e.g., arugula, spinach, kale, red kale, watercress). In some embodiments, adjacent growth systems may be operated with different growing parameters.

The controller 30 can be connected to a fluid supply system that can include a gas supply system 20 and a liquid supply system 86. The controller 30 and fluid supply system may be connected via one or more communications links such as but not limited to 24 and 26, and 85 and 88 for communicating control signals, data, or other information.

The controller 30 can also be connected to the sensing system which can include an imaging system 40, and one or more sensors 70. The controller and sensing system may be connected via a one or more communication links such as but not limited to 44 and 46, and 74 and 76 for communicating control signals, data or other information.

Controller 30 can include a computer readable medium 38, for example random access memory (RAM), read only memory (ROM), Flash memory, optical disk, magnetic drive or other computer readable medium, the readable medium 38 containing a set of control instructions 32 for controlling the operation of the sensing system including the imaging system 40 and one or more sensors 70, and for controlling the operation of the gas supply system 20 and liquid supply system 86. A processor 34 (e.g., CPU, ASIC, RISC or other processor) can execute the instructions. For example, in the non-limiting embodiment of FIG. 1, controller 30 communicates with one or more of imaging system 40 via communications links 44 and 46; communicates with gas supply system 20 via communication links 24 and 26; communicates with liquid supply system 86 via communication links 85 and 88, communicates with one or more sensor(s) 70 via communication links 74 and 76; wherein the one or more communications links can be networks (e.g., Ethernet, wireless network, Bluetooth, global area network, DeviceNet network or other network known or developed in the art), a bus (e.g., SCSI bus) or other communications link. Controller 30 can be implemented as an onboard PCB board, remote controller or in other suitable manner Controller 30 can include appropriate interfaces 36 (e.g., network interfaces, I/O interfaces, analog to digital converters and other components) to facilitate communication between controller 30 and the imaging system 40, sensors 70, the gas supply system 20, and/or liquid supply system 86 via communication links 44 and 46; 74 and 76, 24 and 26, and 85, 88 respectively, as described above. Controller 30 can include a variety of computer components including processors, memories, interfaces, display devices, peripherals or other computer components. In the system 10, the controller 30 can also control various valves such as 21 and 83 for delivering gas and/or a water-based, a nutrient-based, or a water- and nutrient-based solution to the growth medium 82, the controller 30 can control one or more lighting sources or lamps 84 which can be light emitting diodes or high pressure sodium lamps, and the controller 30 can control other inputs to germinate one or more seeds 94 and develop one or more plants 90 with roots 92. Controller 30 can execute instructions 32 which are operable to implement embodiments of the systems and methods described herein.

Optionally, any of the components such as imaging system 40 with imager 48, sensor(s) 70, gas supply system 20, and liquid supply system 86, can separately include a controller that can be adapted to substitute for or cooperate with the controller 30. For example, the imaging system may include a controller with inputs, outputs, interfaces, microprocessor, instructions, and computer readable medium that can be used to control the imager 48 and that may be adapted and substituted to provide the functions of controller 30. In embodiments of the disclosure, reference to a controller includes a separate controller or any controller as part of a component that includes the features of controller 30 as detailed herein.

Embodiments of the disclosure include a sensing system that can include one or more imaging sensors 40 and one or more fluid sensors 70 that characterize the developing plants in the growth system 80. The imaging system 40, in embodiments of the disclosure, may be moved or translated in the x, y, and z directions (only the x-direction 42 is illustrated) with respect to the developing plants 90, seeds 94, or growth medium 82. Alternatively, the imaging system 40 remains fixed and the growth medium and plants are moved (not shown). The one or more sensors 70 can also be movable or translated in the x, y, and z directions through the growth system 80. The characterization of the developing plants in the growth system can be made by a sensing system that includes one or more sensors, an imaging system, any combination of these including only sensors or only an imaging system.

The imaging system or machine vision system 40 can, for example, utilize cameras, reflected light, fluorescence, or infrared radiation to capture an image of and characterize the developing plants, seeds, and to detect overspray; plant damage; stage of plant morphology such as first true leaves, loss of cotyledons, leaf size; provide an indication of plants that the gas velocity is too high or too low.

One or more sensor(s) 70 can be installed to measure the properties of the gas 22 provided to the growth medium, seeds, and developing plants. Gas properties which can be sensed can include, but are not limited to gas velocity, gas mass flow rate, gas temperature, gas composition, relative humidity and the like. Gas concentration sensors incorporated into the system can communicate with the controller 30 and provide a measure of the gas composition and concentrations delivered to and surrounding the region of the developing plants. The gas composition sensors can measure one or more of carbon dioxide, oxygen, water (humidity), or any combination of these. A combination of gas flow sensor(s), gas velocity sensor(s), and gas concentration sensor(s) can be used with the controller, imaging system, and gas supply system to change the composition and/or flow of gas to the developing plants from one gas system supply state to a different gas system supply state based on inputs from the imaging system and optionally one or more gas flow and or gas velocity sensor(s) and gas composition sensor(s). The position of the one or more sensors 70 can be upstream or downstream of the growth medium (shown as downstream in FIG. 1); gas sensors can be positioned upstream and downstream of the developing plants to provide a measure how the gas supply is modified after contacting the developing plants.

A baseline characterization or profile of the one or more seeds, developing plants, or combination of these on the growth system may be established by the controller in communication with the sensing system. A time series of sensor readings and or digital images may be averaged by the controller to create a time-averaged baseline characterization of the developing plants. The time-averaged baseline characterization of the developing plants can be created for example, but not limited to, taking readings and or digital images every minute or few minutes for the first 10-60 minutes of a plant growth cycle or upon a change from one fluid supply state to another fluid supply state. Subsequent readings or digital images during a particular fluid supply state may be taken over longer time intervals, for example every 2 hours, and compared with the time-averaged baseline characterization to ascertain whether the current characterization is outside of a tolerance or threshold and the appropriateness of the fluid flow to the growth system. The baseline characterization or a library of baseline characterizations can be stored in the controller's memory and accessed for comparison to a current operating characterization.

A baseline image characterization can also be obtained once the seeds are spread on the growth medium, or when a flat (cloth and frame) with seeds or germinating seeds is placed in a growth system. A baseline image can be obtained from the imaging system 40 (e.g., machine vision, camera, color, or leaf sensor) in an initial time interval (0-3 days).

An operating characterization or profile may be created by recording one or more values of sensor readings and or digital images during operation of the growth system and fluid supply system. The values of the baseline characterization and the operating characterization may then be compared at one or more points or sets of points. If the operating characterization differs from the baseline characterization by more than a predetermined tolerance or threshold, the appropriateness of the fluid flow can be determined and one or more actions may be taken. Actions that may be taken include for example, but not limited to, sending an alarm to the user, modifying (e.g., increasing, decreasing or ceasing) the nutrient solution fluid flow, modifying gas system supply flow to the one or more plants, or any combination of these.

A library of known baseline characterizations for various plant varieties like arugula, spinach, kale, red kale, watercress, and the like can be created for different stages in each of these plant development cycles. These characterizations, which can include information on when and the amount first true leaves appear, when cotyledons fall off and the number or percent of total cotyledons that fall off, leaf size distributions, and the like may be saved and used to determine the appropriateness of fluid flow to the growth system for particular plants. In one particular embodiment, the characterizations for the library are taken at any time between 1 hour and 12 hours apart.

In embodiments of the disclosure, the gas supply system provides gas 22 to the growth system 80 and can include one or more fans, one or more gas cylinders, one or more fans supplemented with gas from one or more gas cylinders or gas generators, or any combination of these that supplies gas to the plants. In some embodiments, gas from a gas cylinder or gas generator is supplied to the room containing the growth system and is circulated across the developing plants. The term “gas” as used in embodiments of the disclosure and claims, refers to those gases which allow developing plants to grow. Air is an example of a gas. Air can be supplemented or made deficient in one or more other gases like water vapor, carbon dioxide, and oxygen during plant development. An appropriate gas supply state exists when gas velocity is sufficient for gas exchange by the plants without damaging the plants. Plant damage can include broken or bent stems, broken leaves, broken or bent petioles. The appropriateness of gas supply can in some embodiments of the disclosure be determined by characterizing images of the developing plants and comparing them in view of a threshold with baseline or reference images. Gas may also be supplied to the system through the nozzles 89. In embodiments of the disclosure gas velocity can be varied stepwise, continuously, or any combination of these. The variation in gas velocity can be linear or non-linear over a time interval.

In some embodiments, the gas velocity or gas volumetric flow can be increased throughout the development of the plants until harvest. For example, the gas velocity for a growth medium containing 80% or more germinated seeds can be between 2 feet per minute and 50 feet per minute. The gas velocity can be increased to greater than 50 feet per minute after the appearance of an amount of first true leaves, for example 50% or more of the developing plants have first true leaves, on the growth medium. The gas speed can be further increased to above 200 feet per minute once greater than 50% of the leaves of the developing plants reach a target dimension or area as determined by the sensing system and controller.

In some other embodiments the gas supply can be changed throughout the plant development based on a characterization of the developing plants and amount of time in the growth system. For example, following germination of seeds (emergence of radical) on a growth medium (0-3 days), the velocity of gas supplied to the developing plants on the medium over the next 6-8 days can be from between 0 and 90 feet per minute after which the gas velocity can be increased up to a velocity of between 90 fpm and 150 fpm over the next 5-7 days and optionally increased further to a velocity of between 150 fpm and 220 fpm until the plants are harvested.

Separately and/or concurrently, the gas composition in addition to the gas velocity can be changed. For example, following germination of seeds (emergence of radical) on a growth medium (0-3 days), the velocity of gas supplied to the developing plants on the medium over the next 6-8 days can be from between 0 and 50 feet per minute with a carbon dioxide concentration of 400 parts per million by volume (v/v), after which the gas velocity can be increased up to a velocity of between 50 fpm and 160 fpm over the next 5-7 days with a carbon dioxide concentration of between 400 ppm_{v/v} and 800 ppm_{v/v}; optionally a further increase in the gas velocity to between 160 fpm and 240 fpm or higher with an increase in carbon dioxide concentration of 800 ppm_{v/v} or higher can be made until the plants are harvested. Other combinations of gas flow rate or gas velocity, carbon dioxide concentration, humidity and other gases can be used that benefit the developing plants. Gas velocity can be determined using an anemometer or other sensor positioned upstream and/or downstream of the plants in the growth system. The anemometer can be positioned a specific distance, for example 12 inches, from the outlet of the gas supply and the velocity measured. Gas velocity, for example essentially 90 fpm or more, can be beneficial for more developed plants, those having first true leaves or a specific target morphology, and plant canopies in general by facilitating gas circulation and gas exchange without damaging the plants.

The nutrient supply system in embodiments of the disclosure includes one or more nozzle(s) 89 or sprayers that convert a pressurized supply of a nutrient solution that is controlled by one or more on-off and/or proportioning valve(s) 83 connected to a supply of the nutrient solution. The nozzles can be used to create fine droplets 87 such as a mist or fog of the nutrient solution. A valve can be connected to each nozzle or a series of nozzles fed from a single pipe. Pump(s) or gas pressure can be used to flow nutrient solution from a supply vessel (not shown) to the nozzle 89 or sprayers.

A first fluid supply system state differs from the second fluid supply system state in one or more of liquid flow to the nozzles, gas flow rate, gas velocity, gas composition, gas temperature, or combination thereof. Likewise, the second fluid supply system state differs from a third fluid supply system state in one or more of liquid flow to the nozzle, gas flow rate, gas velocity, gas composition, temperature, or combination thereof and so on for additional gas supply states. A first gas supply system state differs from the second gas supply system state in one or more of gas flow rate or gas velocity, gas composition, temperature, or combination thereof. Likewise, the second gas supply system state differs from a third gas supply system state in one or more of gas flow rate, gas velocity, gas composition, temperature, or combination thereof and so on for additional gas supply states. A first liquid supply system state differs from the second liquid supply system state in one or more of liquid flow to the nozzle, liquid or nutrient composition, temperature, or combination thereof. Likewise the second liquid supply system state differs from a third liquid supply system state in one or more of liquid flow rate to the nozzle, liquid or nutrient composition, temperature, or combination thereof and so on for additional liquid supply states. The liquid can be a water-based, a nutrient-based, or a water- and nutrient-based solution.

The appropriateness of fluid flow in embodiments of the disclosure can be determined with reference to the expression or presence of a particular plant morphology of the developing plants that has been characterized by the sensors, imaging or machine vision system, and controller. The appropriateness of the fluid flow in embodiments of the disclosure can be determined by taking the analyses, results, or characterization of readings of the growth system and/or developing plants from the one or more sensors and comparing these with corresponding baseline readings at the start of plant development or at the start of a new fluid supply system state in view of a threshold or tolerance. For example, for a gas flow velocity of 50 feet per minute or less to be an appropriate fluid flow in a first gas supply system state for the growth system, the threshold percent of the amount of developing plants with first true leaves may be set to be 80% or less. Where an analysis or characterization of the image of the growth system in this first gas system supply state for the developing plants shows that the percent of plants with first true leaves is 70%, the characterization is within the threshold and accordingly the fluid flow state of the growth system is appropriate and is not changed. However, where an analysis or characterization of the image of the growth system in this first gas system supply state for the developing plants shows that the percent of plants with first true leaves is 90%, the characterization is outside the threshold and accordingly the fluid flow state of the growth system is not appropriate and is changed. In another example for nutrient overspray, the threshold may be between 0% and 1% of the area of the growth medium may be subject to overspray as determined by mist detection and/or plant leaf damage using the imaging system. Where an analysis or characterization of an image of the growth system shows overspray occurring over 2% of the area of the growth medium, which is outside the threshold, the fluid flow (e.g., nutrient-based solution) to the growth system is not appropriate and may be reduced or stopped. In another example, where the gas flow velocity is measured and characterized by an anemometer downstream of the developing plants on a growth medium during plant development, for example (0-6 days after germination), and where the gas velocity falls (as measured by the anemometer) to 20% of the target threshold flow (for example from 100 fpm to 80 fpm) due to canopy establishment and development, the fluid flow to the growth system is outside of the threshold, is not appropriate, and corrective action may be taken to increase the gas flow velocity to an appropriate fluid flow.

The integrity of the canopy may be a beneficial indicator of performance. Thus, one indicator of appropriate fluid supply (e.g., gas, nutrient solution) is the integrity of the canopy and absence of bare spots (with or without algae). For example, appropriate fluid supply may be demonstrated by an absence of a canopy break and/or by having less than 5% of the growth medium or flat area that was seeded have a break in the canopy.

Embodiments of the disclosure can utilize the sensor system's one or more sensors and imaging system to characterize the developing plants in the growth system and determine the appropriateness of the fluid flow to the growth system by comparing the current characterization of the developing plants with a baseline characterization of the developing plants or a library characterization of the developing plants at a specified number of days or within a specified window of plant development morphology. When the difference between the current characterization of the developing plants and the baseline or library characterization exceeds a predetermined threshold, the present fluid flow may not be appropriate and the state of the fluid supply system can be changed. In some embodiments the controller and one or more sensors and imaging system can detect and characterize for appropriateness of the fluid flow the amount of plants with first true leaves in the growth system. In other embodiments the controller and one or more sensor(s) and imaging system can detect and characterize the fluid flow for appropriateness of one or more of nutrient overspray, amount of plants with first true leaves, gas velocity, or any combination of these in the growth system. In some other embodiments the controller and one or more sensors and imaging system can detect and characterize the fluid flow for appropriateness of one or more of nutrient overspray, canopy establishment, plant damage, amount of plants with first true leaves, loss of cotyledons, leaf size, measuring gas velocity, the presence of pathogens, or any combination of these in the growth system.

The appropriateness of the fluid flow in the growth system can also be manifest by the spread of pathogens as determined by fluorescence and deficiencies compared to healthy developing plants, green ratios, spots from overspray.

An appropriate nutrient fluid flow supply state exists when no overspray, or essentially no overspray (less that 1% of the area of developing plants) is detected by the imaging system or other sensors. Measures of overspray can include spotting of plant leaves, nutrient mist or fog imaged above the growth medium through holes, openings, or gaps. Overspray in embodiments of the disclosure can be detected by the presence of excess liquid (water, a nutrient composition) in the form of droplets, mist or fog that originates from one or more nozzle(s), sprayer(s), and the like located below the growth medium in an aeroponic system and that passes through openings or bypasses the growth medium. Overspray above the growth medium can deposit droplets or a liquid film on plant surfaces (leaves, stems) and the top of the growth medium surface. Overspray occurs when one or more holes or openings in the growth medium or gaps between the edge of the growth medium and the frame allow the nutrient liquid droplets, mist, fog, or spray to flow from below the growth medium through to the top surface of the growth medium. Overspray can be detected by an imaging system in the air or gas above the growth medium based on changes in light scattering; as a film of liquid droplets accumulating on top surfaces of developing plants and the growth medium (like fog on a mirror) due to light scattering; as nutrient solution residue on plant leaves; as browning of plant leaves; by a Doppler effect; or any combination of these. Overspray is an inappropriate fluid flow condition that can lead to undesirable algal growth on plants and growth media, fungal growth, plant rot and higher growing costs. In some embodiments, the aeroponic system is substantially free, or is free, of any added algicide, fungicide, or combination of these.

In embodiments of the disclosure the controller 30 communicates with the sensing system and the fluid supply system. The controller is configured to receive and send information to and from the sensing system and the fluid supply system. The controller 30 comprises a processor 34 and a tangible, non-transitory computer readable medium 38 storing a set of instructions 32 executable to cause the controller 30 to characterize the developing plants in the growth system, monitor the operation of the growth system, monitor and operate the sensing system, monitor and operate the fluid supply system, or any combination of these. The controller can be coupled to the fluid supply system, the sensing system, and is operable to receive inputs from sensors and imaging devices and send instructions to these same devices, valves and fans, and other fluid flow regulating and mixing devices. The controller, utilizing a computer program product, can create an operating characterization corresponding to a parameter of the developing plants (e.g., color, density, height, plant morphology such as first true leaves, deficiencies, pathogens) and compare each of one or more values associated with the operating characterization with a corresponding value associated with a reference or baseline characterization for a particular parameter to determine if each of the one or more values is within a tolerance of the corresponding value. The computer program product can comprise a set of computer instructions stored on one or more computer readable media that include instructions executable by one or more processors to create the operating characterization or profile and compare the operating characterization with a corresponding value associated with a baseline or library characterization to determine if each of the one or more values is within a tolerance of the corresponding value.

Embodiments of the disclosure provide an advantage by detecting a variety of problems relating to inappropriate fluid flows in growth systems and in particular aeroponic growth system. For example, by comparing an operating characterization of the developing plants at one or more time intervals or plant morphology stages with a baseline or a library of operating characteristics, performance issues may be identified which may be attributable to factors that include, but are not limited to, incorrect air velocity, overspray, presence of pathogens, insufficient lighting, nutrient spray, and other conditions may be detected and corrected. Each position in the growth system can be treated as its own microclimate. The airflow, nutrient solution flow, or any combination of these may be changed in each microclimate depending on the requirements of that position.

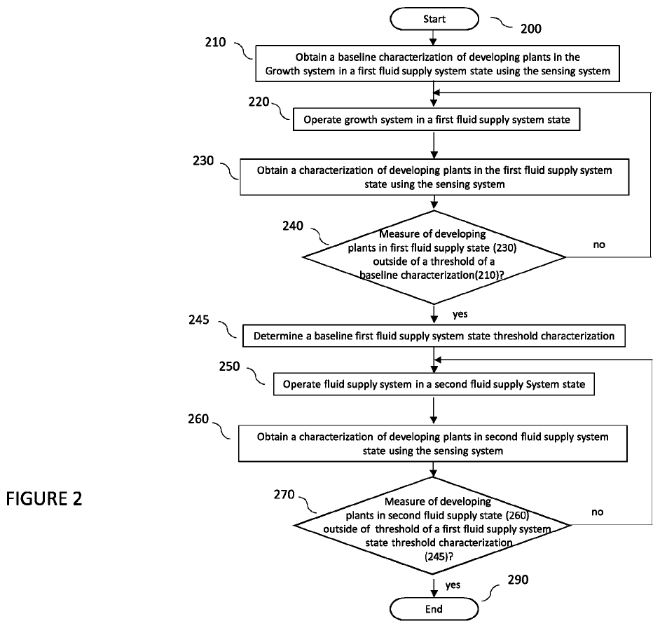

FIG. 2 illustrates a method in an embodiment of the disclosure for controlling the fluid supply to the developing plants and seeds in a growth system. The method includes obtaining a baseline plant characterization 210 for a growth system including one or more seeds 94, developing plants 90, or a combination thereof on the growth medium 82. The baseline characterization 210 can be obtained prior to any fluid flow into the growth system, from a library characterization, or with the growth system in a first fluid supply system state. The baseline characterization 210 can include a characterization of the morphology of developing plants on the growth medium including such features, for example but not limited to, the presence or number of radicals, amount of plants with first true leaves, amount of plants with or without cotyledons. The growth system is then operated in the first fluid supply system state 220 by controlling the fluid supply system (20, 86), temperature, and supplying light as needed. The sensing system and controller are used to obtain a first fluid supply state characterization 230 for the one or more seeds 94, developing plants 90, or any combination thereof on the growth medium 82. The controller 30 measures or determines 240 if the first fluid supply system state characterization 230 is outside of a tolerance or threshold of the baseline characterization 210 based on a comparison of plant morphologies, for example, the presence or amount of radicals, amount of plants with first true leaves, amount of plants with or without cotyledons. Based on this comparison, the controller determines 240 the appropriateness of the first fluid supply system state delivered to the growth system. If the first fluid supply system state is appropriate and the characterization is not outside of the threshold, the controller continues to operate the growth system and returns to 220. If the first fluid supply system state to the growth system is not appropriate and the characterization is outside of the threshold, the controller can take the last characterization 230, or make a final characterization, and thereby obtain a baseline first fluid supply system state threshold characterization 245. The controller then operates the growth system to correct the inappropriate fluid supply by changing the fluid supply system (20, 86) to a second fluid supply system state 250. With the fluid supply system operating in the second fluid supply system state, the controller obtains a second fluid supply state characterization 260 for the one or more seeds 94, developing plants 90, or any combination thereof on the growth medium. The controller 30 measures or determines 270 if the second fluid supply state characterization 260 is outside of a predetermined tolerance or threshold of the baseline first fluid supply system state threshold characterization 245 based on a comparison of the morphology of the developing plants on the growth medium including such features as, for example but not limited to, the presence or amount of radicals, amount of plants with first true leaves, amount of plants with or without cotyledons. Based on this comparison, the controller determines 270 the appropriateness of the second fluid supply system state for the growth system. If the second fluid supply state is appropriate and the characterization is not outside of the threshold, the controller continues to operate the growth system and returns to 250. If the second fluid supply state provided to the growth system is not appropriate and the characterization is outside of the predetermined threshold, the controller can end this process 290 and/or take additional step (not shown) including having the sensing system and controller make a final characterization for subsequent steps with a new fluid supply state and characterizations; indicating the plants are ready for harvesting; indicating the plants are ready for harvesting and calculating a height to cut the plants; or any combination including one or more of these.

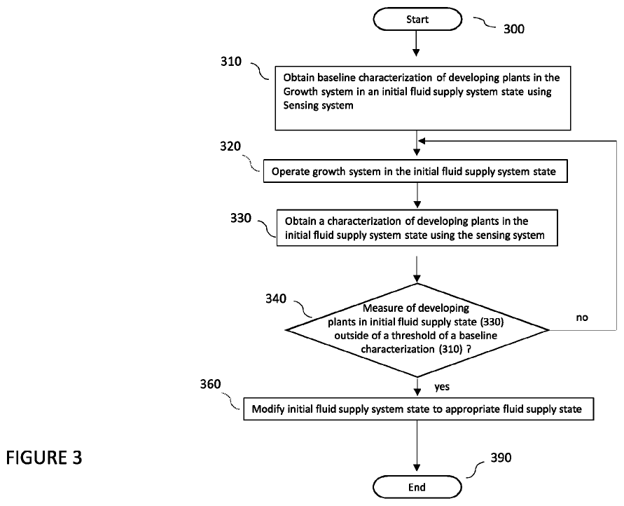

FIG. 3 is a flow chart illustrating an embodiment of the disclosure where gas velocity, nutrient solution flow, or both to the developing plants can be maintained or modified based on a characterization by the sensing system. The baseline characterization 310 can include a characterization of the morphology of developing plants on the growth medium including one or more plant morphology features such as the presence or amount of radicals, amount of plants with first true leaves, amount of plants with or without cotyledons, as well as growth system features such as overspray and/or gas velocity. The baseline characterization 310 can be obtained prior to any fluid flow into the growth system, from a library characterization, or with the growth system in an initial fluid supply system state. In the non-limiting case of nutrient solution flow, for example, a baseline characterization of one or more image(s) of the developing plants and optionally inputs from one or more sensors in the sensing system can optionally be made 310 in an initial nutrient solution supply system state. The growth system is then operated in the initial nutrient solution supply system state 320. Characterization of the developing plants and optionally inputs from one or more sensors can be made of the developing plants in the initial nutrient solution supply system state 330. The baseline characterization 310 and the characterization of the developing plants after being grown in the initial nutrient solution supply system state 330 may be compared 340. If the initial nutrient solution supply system state 320 is appropriate, for example no overspray is detected by the machine vision system or doppler, and the characterization is not outside of the predetermined threshold, the controller continues to operate the growth system and returns to 320. If the characterization after operation in the initial nutrient solution supply system state (330) differs from the baseline characterization (310) by more than a certain tolerance or threshold, indicative of an overspray condition, the nutrient fluid flow is not appropriate and one or more actions may be taken by the controller. If the controller detects an overspray condition it can engender programmed change to an appropriate fluid supply state 360 from the initial nutrient solution flow state 320 by modifying or stopping the flow of nutrient solution delivered through one or more nozzle(s) to the developing plants in the aeroponic growth system.

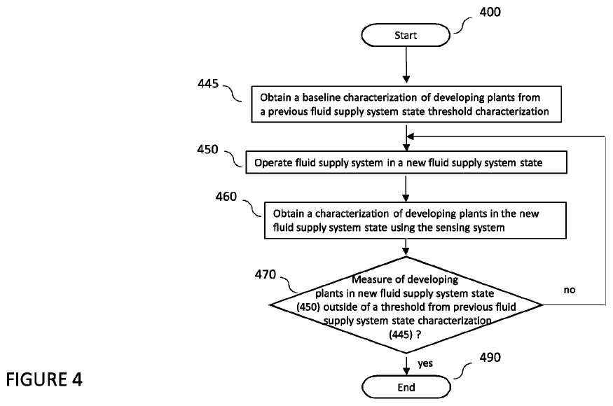

FIG. 4 is a flow chart illustrating an embodiment of the disclosure where gas flow, nutrient solution flow, or both are provided to the developing plants and may be maintained or modified based on a characterization by the sensing system. A baseline characterization of the developing plants in a previous fluid supply state (e.g. 240, 340) is made 445 by the sensing system and controller. The growth system can be operated in new fluid flow state 450, for example with modified air flow velocity and/or nutrient solution flow. A characterization of the growth system in this new fluid supply state is obtained 460 of the developing plants and from the imaging system and optionally inputs from one or more sensors. The characterization of the developing plants in the previous fluid supply state 445 and the characterization of the developing plants in the new fluid flow state 460 may then be compared 470. If the new fluid flow supply state 450 is appropriate and the characterization is not outside of the threshold, the controller continues to operate the growth system and returns to 450. If the characterization of the growth system in the new fluid flow state 460 differs from the characterization in the previous fluid supply state 445 by more than a certain tolerance or threshold, the nutrient fluid flow and/or gas flow are/is not appropriate and one or more actions taken by the controller. If for example, based on the comparison of these characterizations, the controller detects a gas flow velocity condition that is too low, it can engender programmed change to the gas flow by increasing the velocity of a gas such as air delivered to the developing plants in the aeroponic growth system. Alternatively, if the gas velocity or gas flow to the growth system is not appropriate and the characterization is outside of the threshold, the controller can end 490 this process and/or take additional step (not shown) including having the sensing system and controller make a final characterization for subsequent steps with another fluid supply state and characterizations; indicating the plants are ready for harvesting; indicating the plants are ready for harvesting and calculating a height to cut the plants; or any combination including one or more of these.

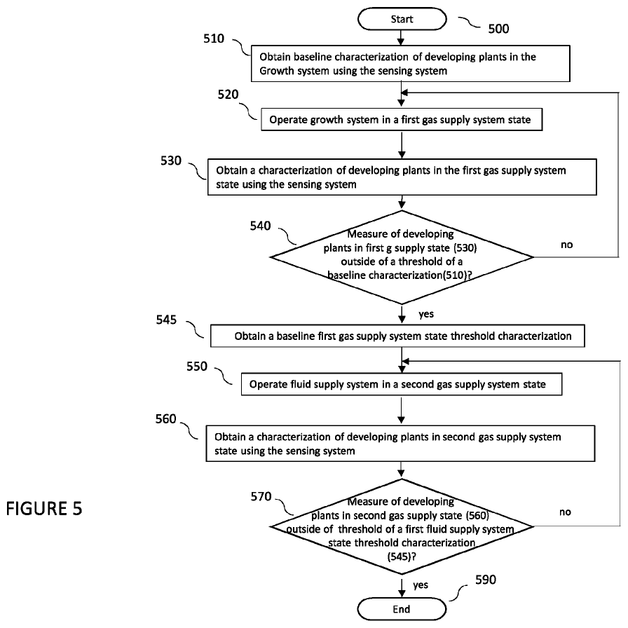

FIG. 5 illustrates a method in an embodiment of the disclosure for controlling the gas velocity and gas supply to the developing plants and seeds in a growth system. The method includes obtaining a baseline plant characterization 510 for a growth system comprising one or more seeds 94, developing plants 90, or a combination thereof on the growth medium 82. The baseline characterization 510 can be obtained prior to any fluid flow into the growth system, from a library characterization, or with the growth system in a first gas supply system state which may be a gas velocity of between 0 and 50 fpm, preferably between 2 fpm to 10 fpm, and with or without nutrient solution spray to the growth medium. The baseline characterization 510 can include a characterization of the morphology of developing plants on the growth medium including such features as the presence or number of radicals, amount of plants with first true leaves, amount of plants with or without cotyledons. The growth system is then operated in the first gas supply system state 520 by controlling the gas supply system 20. A spray of nutrient solution can be provided to the growth medium. The sensing system and controller are used to obtain a first gas supply state characterization 530 for the one or more seeds 94, developing plants 90, or any combination thereof on the growth medium 82. The controller 30 measures or determines 540 if the first gas supply state characterization 530 is outside of a predetermined tolerance or threshold of the baseline characterization 510 based on a comparison of, for example, the presence or amount of radicals, amount of plants with first true leaves, amount of plants with or without cotyledons. Based on this comparison, the controller determines 540 the appropriateness of first gas supply state to the growth system. If the gas velocity or gas flow is appropriate and the characterization is not outside of the threshold, the controller continues to operate the growth system and returns to 520. If the gas velocity or gas flow to the growth system is not appropriate and the characterization is outside of the threshold, the controller can take the last characterization 530, or make a final characterization, and thereby obtain a baseline first gas supply system state threshold characterization 545. The controller then operates the growth system to correct the inappropriate gas flow by changing the gas supply system 20 to a second gas supply system state 550. With the gas supply system operating in a second gas supply system state, the controller obtains a second gas supply state characterization 560 for the one or more seeds 94, developing plants 90, or any combination thereof on the growth medium. The controller 30 measures or determines 570 if the second gas supply state characterization 560 is outside of a predetermined tolerance or threshold of the baseline first gas supply system state threshold characterization 545 based on a comparison of, for example, the presence or amount of radicals, amount of plants with first true leaves, amount of plants with or without cotyledons. Based on this comparison, the controller determines 570 the appropriateness of the second gas supply state to the growth system. If the gas velocity, composition, gas flow, or combination of these in the second gas supply state is appropriate and the characterization is not outside of the threshold, the controller continues to operate the growth system and returns to 550. If the gas velocity or gas flow to the growth system is not appropriate and the characterization is outside of the threshold, the controller can end this process 590 and/or take additional step (not shown) including having the sensing system and controller make a final characterization for subsequent steps with a new gas supply state and characterizations; indicating the plants are ready for harvesting; indicating the plants are ready for harvesting and calculating a height to cut the plants; or any combination including one or more of these.

The following clauses define particular aspects and embodiments of the disclosure.

Clause 1. A sensing system for a plant growth system 80, the plant growth system including a soilless growth medium 82, a fluid supply system (20 and 86) that supplies one or more fluids to the growth system 80 and developing plants in the growth system, and one or more lamps 84 that supply light to the growth system, the sensing system including;
one or more sensors (40, 70) that characterize the growth system including the developing plants;
a controller 30 in communication with the one or more sensors and the fluid supply system, the controller configured to receive and send information from and to the one or more sensors (40, 70) and the fluid supply system (20, 86), the controller 30 including a processor 34 and a tangible, non-transitory computer readable medium 38 storing a set of instructions 32 executable to cause the controller 30 to:
characterize an appropriateness of fluid flow for the growth system; and
determine whether to adjust delivery of fluid to the developing plants in the growth system.

Clause 2. The sensing system of clause 1 wherein the sensing system includes a gas velocity sensor and an imaging system.

Clause 3. The sensing system of clause 1 or 2 wherein the appropriateness of fluid flow in the growth system is based on plant morphology.

Clause 4. The sensing system as in any one of clauses 1 or 2 wherein the appropriateness of fluid flow in the growth system is based on the amount of nutrient overspray of the soilless growth medium.

Clause 5. The sensing system as in any one of clauses 1-4 wherein the controller is further operable to stop the fluid supply system flow after a threshold number of plants have reached a predetermined height and calculate a cutting height.

Clause 6. The sensing system as in any one of clauses 1-5 wherein the one or more of the sensors is a gas velocity sensor in communication with the controller.

Clause 7. The sensing system as in any one of clauses 1-6 where in the sensing system includes an imaging system that utilizes fluorescence.

Clause 8. The sensing system as in clause 7 wherein the image system is connected to a translating fixture that moves the image system in one or more directions.

Clause 9. The sensing system as in any one of clauses 1-8 wherein the controller is connected to a nutrient supply system.

Clause 10. The sensing system as in any one of clauses 1-8 wherein the appropriateness of the fluid flow in the growth system is based on the absence of a canopy break.

Clause 11. The sensing system as in any one of clauses 1-8 wherein the appropriateness of the fluid flow in the growth system is based on having less than 5 percent of the soilless growth medium that was seeded have a break in the canopy.

Clause 12. A method of germinating seeds and growing plants comprising:
obtaining a baseline plant characterization 510 for a growth system comprising one or more seeds 94, developing plants, or any combination thereof on a soilless growth medium 82 using a sensing system comprising one or more sensors (40, 70);
operating a gas supply system 20 in a first gas supply system state 520;
determining a first gas supply state characterization 530 for the one or more seeds 94, developing plants or any combination thereof on the soilless growth medium 82;
determining if the first gas supply state characterization 530 is outside of a threshold of the baseline characterization 510, and determining a baseline first gas supply system state threshold characterization 545;
operating the gas supply system 20 in a second gas supply system state 550;
determining a second gas supply state characterization 560 for the one or more seeds 94, developing plants (90), or any combination thereof on the soilless growth medium 82; and
determining 570 if the second gas supply state characterization 560 is outside of a threshold of the baseline first gas supply system state threshold characterization 545.

Clause 13. The method of clause 12 wherein the gas velocity in the first gas supply state is less than 90 feet per minute at the outlet of the gas supply system, the gas velocity in the second gas supply system state is between 90 feet per minute and 220 feet per minute and the first gas supply state characterization 530 is outside of a threshold of the baseline characterization 510 when the amount of plants with first true leaves on the soilless growth medium is greater than 50 percent of all the developing plants on the soilless growth medium.

Clause 14. The method of clause 12, wherein gas system supplies carbon dioxide gas.

Claim 15. The method of clause 12, wherein the sensing system determines the absence of a canopy break.

Claim 16. The method of clause 12, wherein the sensing system determines whether less than 5 percent of the growth medium that was seeded has a break in the canopy.

Clause 17. A method of delivering fluid from a fluid supply system to an aeroponic growth medium or flat containing developing plants in an aeroponic growth system that includes using a sensing system to characterize the developing plants in the aeroponic growth system for an appropriate fluid delivery to the growth system and determining whether to adjust delivery of fluid to said flat containing developing plants in the aeroponic growth system.

Clause 18. The method of clause 17 wherein an appropriate fluid delivery to the growth system includes determining that an amount of nutrient solution overspray from below the growth medium or flat is less than 2% of the area of the growth medium.

Clause 19. The method as in any one of clauses 17-18 wherein an appropriate fluid delivery to the growth system includes determining a number of developing plants that have of the first true leaves.

Clause 20. The method as in any one of clauses 17-19 wherein the fluid supply system includes a nutrient supply system that provides nutrients directly to roots of the developing plants and a gas supply system that provide gas to the developing plants.

Clause 21. The method as in any one of clauses 17-20 wherein the appropriate fluid delivery to the growth system includes determining the amount of nutrient solution overspray from below the growth medium or flat and determining the number of developing plants that have first true leaves.

Clause 22. The method as in any one of clauses 17-21 wherein a determination to adjust delivery of fluid to said growth medium or flat containing developing plants in the growth system further includes changing a gas supply system state.

Clause 23. The method as in any one of clauses 17-22 wherein a determination to adjust delivery of fluid to said growth medium or flat containing developing plants in the growth system includes changing a nutrient supply system state.

Clause 24. The method as in any one of clauses 17-23 wherein a determination to adjust delivery of fluid to said growth medium or flat containing developing plants in the growth system includes changing a gas supply state, a nutrient supply system state, or both.

Clause 25. The method as in any one of clauses 17-24 further comprising treating a bottom surface of the growth medium with nutrient fog, nutrient mist, or a combination of these during plant development.

Clause 26. The method as in any one of clauses 17-25 wherein the appropriate fluid delivery to the growth system includes determining the absence of a canopy break.

Clause 27. The method as in any one of clauses 17-26 wherein the appropriate fluid delivery to the growth system includes determining whether less than 5 percent of the soilless growth medium that was seeded has a break in the canopy.

Approximating language, as used herein throughout the specification and claims, may be applied to modify any quantitative or qualitative representation that could permissibly vary without resulting in a change in the basic function to which it is related. Accordingly, a value modified by a term such as “about” or numerical ranges is not to be limited to a specified precise value, and may include values that differ from the specified value. In at least some instances, the approximating language may correspond to the precision of an instrument for measuring the value

While the disclosure has been described in detail in connection with only a limited number of aspects and embodiments, it should be understood that the disclosure is not limited to such aspects. Rather, the disclosure can be modified to incorporate any number of variations, alterations, substitutions, or equivalent arrangements not heretofore described, but which are commensurate with the scope of the claims. Additionally, while various embodiments of the disclosure have been described, it is to be understood that aspects of the disclosure may include only some of the described embodiments. Accordingly, the disclosure is not to be seen as limited by the foregoing description but is only limited by the scope of the appended claims.

What is claimed is:

1. A sensing system for a plant growth system, the plant growth system comprising:
a soilless growth medium, a fluid supply system that supplies one or more fluids to the growth system and developing plants in the growth system, and one or more lamps that supplies light to the growth system,
the sensing system comprising;
a. one or more sensors;
b. a controller in communication with the one or more sensors and the fluid supply system, the controller configured to receive and send information to and from the one or more sensors and the fluid supply system, the controller comprising a processor and a tangible, non-transitory computer readable medium storing a set of instructions executable to cause the controller to:
i. determine an appropriateness of a fluid flow from the fluid supply system into the growth system based on a characterization selected from the group consisting of an amount of plants with first true leaves, an amount of nutrient overspray of the soilless growth medium, gas velocity, and any combination of these; and
ii. determine whether to adjust the fluid flow from the fluid supply system into the growth system.

2. The sensing system of claim 1, wherein the appropriateness of the fluid flow in the growth system is based on the amount of nutrient overspray of the soilless growth medium.

3. The sensing system of claim 1, further comprising instructions executable to adjust the fluid flow.

4. The sensing system of claim 1, wherein the one or more sensors comprises an imaging system.

5. The sensing system of claim 1, wherein the one or more sensors comprises an anemometer

6. The sensing system of claim 1, wherein the appropriateness of the fluid flow in the growth system is based on the amount of plants with first true leaves.

7. The sensing system of claim 1, wherein the appropriateness of the fluid flow in the growth system is based on the amount of plants with first true leaves and the amount of nutrient overspray of the soilless growth medium.

8. The sensing system of claim 1, wherein the appropriateness of the fluid flow in the growth system is based on the absence of a canopy break.

9. The sensing system of claim 1, wherein the appropriateness of the fluid flow in the growth system is based on having less than 5 percent of the soilless growth medium that was seeded have a break in the canopy.

10. An aeroponic growth system comprising:
a growth system comprising a growth medium and one or more seeds, developing plants, or any combination thereof on the growth medium;
a sensing system comprising one or more sensors configured to characterize the one or more seeds, developing plants, or any combination thereof on the growth medium;
a fluid supply system that supplies one or more fluids to the growth system;
a controller connected to the sensing system and fluid supply system the controller configured to receive and send information to and from the sensing system and the fluid supply system the controller comprising a processor and a tangible, non-transitory computer readable medium storing a set of instructions executable to cause the controller to:
a. operate the sensing system and determine a baseline characterization of the one or more seeds, developing plants, on the growth medium in the growth system;
b. operate the fluid supply system in a first fluid supply system state;
c. operate the sensing system and determine a first fluid supply system state characterization for the one or more seeds, developing plants, or any combination thereof, on a growth medium in the growth system;
d. make a determination whether the first fluid supply system state characterization is outside of a threshold of the baseline characterization for the one or more seeds, developing plants, or any combination thereof on the growth medium, based on one or more of nutrient overspray, an amount of plants with first true leaves, gas velocity, or any combination of these.

11. The aeroponic growth system of claim 10, wherein the sensing system determines nutrient overspray.

12. The aeroponic growth system of claim 10, wherein the sensing system determines the amount of plants with first true leaves.

13. The aeroponic growth system of claim 10, wherein the sensing system determines the absence of a canopy break.

14. The aeroponic growth system of claim 10, wherein the sensing system determines whether less than 5 percent of the growth medium that was seeded has a break in the canopy.

15. The aeroponic growth system of claim 10, wherein the controller is further adapted to:
operate the sensing system and determine a baseline first fluid supply threshold characterization of the one or more seeds, developing plants, on the growth medium in the growth system;
operate the fluid supply system in a second fluid supply system state;
operate the sensing system and determine a second fluid supply system state characterization of the one or more seeds, developing plants, or any combination of these, on a growth medium in the growth system; and
make a determination whether the second fluid supply system state characterization is outside of a threshold of the baseline first fluid supply characterization for the one or more seeds, developing plants, or any combination thereof on the growth medium, based on one or more of nutrient overspray, an amount of plants with first true leaves, gas velocity, or any combination of these.

16. A method of delivering fluid from a fluid supply system to a growth medium containing developing plants in an aeroponic growth system, the aeroponic growth system comprises using a sensing system to characterize the developing plants in the growth system for an appropriateness of fluid flow to the growth system, and determining whether to adjust delivery of fluid to a flat containing developing plants in the growth system.

17. The method of claim 16, wherein the appropriateness of fluid flow to the growth system comprises determining an amount of nutrient solution overspray.

18. The method of claim 16, wherein the appropriateness of fluid flow to the growth system comprises determining a number of developing plants that have first true leaves.

19. The method of claim 16, wherein the fluid supply system comprises a nutrient supply system that provides nutrients directly to roots of the developing plants and a gas supply system that provide gas to the developing plants.

20. The method of claim 16, wherein the appropriateness of fluid flow delivery to the growth system comprises determining the amount of nutrient solution overspray and determining the number of developing plants that have first true leaves.

21. The method of claim 20, further comprising adjusting delivery of fluid to said growth medium containing developing plants in the growth system.

22. The method of claim 21, wherein the adjusting the delivery of fluid comprises changing a nutrient supply system state.

23. The method of claim 21, wherein adjusting the delivery of fluid comprises changing a gas supply state.

24. The method of claim 16, further comprising treating a bottom surface of the growth medium with nutrient mist or fog during plant development.

25. The method of claim 16, wherein the appropriateness of fluid flow to the growth system comprises determining the absence of a canopy break.

26. The method of claim 16, wherein the appropriateness of fluid flow to the growth system comprises determining whether less than 5 percent of the soilless growth medium that was seeded has a break in the canopy.
